(19) United States
(12) Patent Application Publication
(10) Pub. No.: US 2024/0388377 A1
(43) Pub. Date: Nov. 21, 2024

(54) TRANSMISSION APPARATUS, FUNCTION CONTROL APPARATUS SYSTEM, AND SIGNAL PROCESSING METHOD

(71) Applicant: Nippon Telegraph and Telephone Corporation, Tokyo (JP)

(72) Inventors: Takahiro SUZUKI, Musashino-shi, Tokyo (JP); Sang-Yuep KIM, Musashino-shi, Tokyo (JP)

(21) Appl. No.: 18/691,915

(22) PCT Filed: Sep. 21, 2021
(86) PCT No.: PCT/JP2021/034545

§ 371 Date: Mar. 14, 2024

(51) Int. Cl. H04L 1/00; H04B 10/516

(52) U.S. Cl. CPC H04L 1/0003; H04B 10/5161; H04L 1/0006; H04L 1/0009

(57) ABSTRACT

A transmission apparatus includes a scheme identification unit, a function control unit, and a signal processing unit. The scheme identification unit identifies at least one of a modulation scheme, a frame format, or an encoding scheme on the basis of a characteristic of a signal received. The function control unit performs control to cause a signal processing function to operate, the signal processing function depending on a result of identification of the at least one of the modulation scheme, the frame format, or the encoding scheme by the scheme identification unit. The signal processing unit is controlled to operate by the function control unit, and processes the signal received.

### TECHNICAL FIELD

The present invention relates to a transmission apparatus, a function control apparatus, a system, and a signal processing method.

### BACKGROUND ART

As a conventional apparatus configuration of an optical access system, there are (a) an Ethernet frame reception apparatus having an interface of a media converter (MC), (b) a PON specification frame reception apparatus having a passive optical network (PON) interface, and (c) a reception apparatus using digital signal processing having an analog-to-digital converter (ADC).

Conventionally, different apparatuses such as (a), (b), and (c) described above are selectively used depending on a transmission service to be implemented. Non Patent Literature 1 describes a reception apparatus of a type (b). In addition, Non Patent Literature 2 describes a reception apparatus of a type (c).

In addition, in conventional techniques, there is also a method of changing a function to optimize a demodulation scheme or FEC demodulation (FEC is an abbreviation of Forward Error Correction) depending on a transmission state. For example, there is a method of switching a function of demodulating a received signal by QPSK and a function of demodulating a received signal by 16QAM depending on the transmission state. Non Patent Literature 3 describes such a reception apparatus.

In addition, in the conventional techniques, there is a method in which ON/OFF of the FEC function can be changed in one apparatus. In this method, it is necessary to perform negotiation between apparatuses regarding the change of ON/OFF of FEC. As a method for negotiation, there are a method of adding information on ON/OFF of FEC to a preamble of a transmission frame and a method of measuring a bit error rate by an ONU after transmitting a frame from an OLT once and determining ON/OFF of FEC on the basis of the measured bit error rate. Note that, the OLT is an abbreviation for “Optical Line Terminal” and is an optical line terminal apparatus on a telecommunications carrier side. In addition, the ONU is an abbreviation for “Optical Network Unit” and is an optical line terminal apparatus on a subscriber side. Non Patent Literature 4 describes an apparatus that changes ON/OFF of FEC as described above.

In addition, in the conventional techniques, there is a method of identifying a modulation scheme for monitoring a state of a received signal. In the method, a histogram of an amplitude of a received signal is created, and the modulation scheme is identified by using a neighborhood search or the like. Non Patent Literature 5 describes a method for identifying a modulation method as described above.

In addition, in the conventional techniques, there is a method of adopting a configuration of a digital coherent transmitter and receiver that performs polarization multiplexing. In this method, the transmitter separates signal light into polarized waves in the X direction and the Y direction, then modulates each of the polarized waves, multiplexes the polarized waves, and then transmits the multiplexed polarized waves toward a receiver side. In addition, in the receiver, a signal is received by a coherent receiver and separated into pieces of information on optical complex amplitudes in the X direction and the Y direction. Thereafter, clock synchronization and signal detection are performed, and then polarization separation and filter processing are performed. Carrier recovery processing and decoding processing are performed on signals to which polarization separation and filter processing are performed and that are separated into the polarized waves in the X direction and the Y direction at the time of modulation.

### CITATION LIST

### Non Patent Literature

Non Patent Literature 1: “Gijutsu kiso kouza GE-PON gijutsu (in Japanese) (Technical basic course GE-PON Technology)”, NTT Access Service Systems Laboratories, NTT Technical Journal, August 2005, p. 71-74.
Non Patent Literature 2: Ryo Koma, Masamichi Fujiwara, Jun-ichi Kani, Sang-Yuep Kim, Takahiro Suzuki, Ken-Ichi Suzuki, Akihiro Otaka, “Demonstration of Real-Time Burst-Mode Digital Coherent Reception With Wide Dynamic Range in DSP-Based PON Upstream”, Journal of Lightwave Technology, Vol. 35, No. 8, pp. 1392-1398 Apr. 2017.
Non Patent Literature 3: Hideki Nishizawa, Wataru Ishida, Yoshiaki Sone, Takafumi Tanaka, Seiki Kuwabara, Tetsuro Inui, Takeo Sasai, Masahito Tomizawa, “Open whitebox architecture for smart integration of optical networking and data center technology [Invited]”, Journal of Optical Communications and Networking, Vol. 13, No. 1, A78-A87, January 2021, Optical Society of America. Non Patent Literature 4: Jun Sugawa, Koji Wakayama, Hidehiro Toyoda, “Adaptive FEC control in downstream collaborating with traffic control in OLT for WDM/TDM-PON”, 2015 European Conference on Optical Communication (ECOC 2015), Valencia, Spain, 2015. Non Patent Literature 5: Tianliang WANG, Xiaoying LIU, “A novel modulation format identification based on amplitude histogram space”, Front. Optoelectron. 2019, 12 (2): 190-196, 2019.

### SUMMARY OF INVENTION

### Technical Problem

The conventional techniques described above has the following problems.

In a method of selectively using different apparatuses (configurations of Non Patent Literature 1 and Non Patent Literature 2) depending on a transmission service to be implemented, it is necessary to replace the apparatuses when the transmission service is changed.

Although it is possible to switch functions as in the technique described in Non Patent Literature 3, there is no method of selecting an appropriate demodulation scheme and encoding scheme depending on a received signal.

In a method of switching transmission functions (such as ON/OFF of FEC) as described in Non Patent Literature 4, there is a problem that it is necessary to transmit and receive a frame having a special configuration, communication cannot be performed according to an arbitrary protocol, and the system becomes complicated. That is, since negotiation of transmission functions is required between two communication apparatuses, it is necessary to implement a sequence for the negotiation, whereby the system becomes complicated. In addition, there is also a problem that overhead time for switching occurs when the transmission functions are switched.

In the technique described in Non Patent Literature 5, a modulation scheme of a received signal can be identified, but a method is not implemented for switching demodulation schemes or encoding schemes depending on the received signal. In addition, a method has not been studied for implementing identification of the modulation scheme in a reception apparatus in real time. In addition, there is also a problem that an identification rate of the modulation scheme deteriorates when an influence of noise in a communication path increases.

The present invention has been made in view of the above circumstances, and an object of the present invention is to provide a transmission apparatus, a function control apparatus, a system, and a signal processing method capable of correctly processing a signal according to various schemes (modulation scheme, frame format, encoding scheme) by one type of apparatus without selectively using a plurality of types of apparatuses.

### Solution to Problem

To solve the above problem, a transmission apparatus according to an aspect of the present invention includes: a scheme identification unit that identifies at least one of a modulation scheme, a frame format, or an encoding scheme on the basis of a characteristic of a signal received; a function control unit that performs control to cause a signal processing function to operate, the signal processing function depending on a result of identification of the at least one of the modulation scheme, the frame format, or the encoding scheme by the scheme identification unit; and a signal processing unit that is controlled to operate by the function control unit and processes the signal received.

In addition, a function control apparatus according to an aspect of the present invention includes a function control unit that receives, from a transmission apparatus, information on a result of identification of at least one of a modulation scheme, a frame format, or an encoding scheme identified on the basis of a characteristic of a signal received by the transmission apparatus, and performs control to cause a signal processing function to operate in the transmission apparatus, the signal processing function depending on the result of identification received.

In addition, a system according to an aspect of the present invention is a system including a terminal apparatus and a transmission apparatus, in which the terminal apparatus transmits a signal to the transmission apparatus, and the transmission apparatus includes: a scheme identification unit that identifies at least one of a modulation scheme, a frame format, or an encoding scheme on the basis of a characteristic of a signal received from the terminal apparatus; a function control unit that performs control to cause a signal processing function to operate, the signal processing function depending on a result of identification of the at least one of the modulation scheme, the frame format, or the encoding scheme by the scheme identification unit; and a signal processing unit that is controlled to operate by the function control unit and processes the signal received.

In addition, a signal processing method according to an aspect of the present invention is a signal processing method in which: a scheme identification unit identifies at least one of a modulation scheme, a frame format, or an encoding scheme on the basis of a characteristic of a signal received; a function control unit performs control to cause a signal processing function to operate, the signal processing function depending on a result of identification of the at least one of the modulation scheme, the frame format, or the encoding scheme by the scheme identification unit; and a signal processing unit is controlled by the function control unit such that the signal processing function depending on the result of identification operates, and processes the signal received.

### Advantageous Effects of Invention

According to the present invention, it becomes possible to correctly process a signal according to various schemes (modulation scheme, frame format, encoding scheme) by one type of apparatus without selectively using a plurality of types of apparatuses.

### BRIEF DESCRIPTION OF DRAWINGS

FIG. 1 is a block diagram illustrating a schematic functional configuration of a station building side apparatus (transmission apparatus) according to a first embodiment of the present invention.

FIG. 2 is a block diagram illustrating a schematic apparatus configuration of a communication system configured using the station building side apparatus according to the first embodiment.

FIG. 3 is a block diagram illustrating a schematic functional configuration of a station building side apparatus (transmission apparatus) according to a second embodiment.

FIG. 4 is a block diagram illustrating a schematic functional configuration of a station building side apparatus (transmission apparatus) according to a third embodiment.

FIG. 5 is a block diagram illustrating an internal functional configuration of each of a modulation scheme identification unit, a frame identification unit, and an encoding identification unit in the third embodiment.

FIG. 6 is a block diagram illustrating a schematic functional configuration of a station building side apparatus (transmission apparatus) according to a fourth embodiment.

FIG. 7 is a block diagram illustrating an internal functional configuration of a frame identification unit in the fourth embodiment.

FIG. 8 is a block diagram illustrating an internal functional configuration of an encoding identification unit in the fourth embodiment.

FIG. 9 is a block diagram illustrating a schematic functional configuration of a station building side apparatus (transmission apparatus) according to a fifth embodiment.

FIG. 10 is a schematic diagram illustrating a configuration example (first example) of data stored in an encoding scheme storage unit in the fifth embodiment.

FIG. 11 is a schematic diagram illustrating a configuration example (second example) of the data stored in the encoding scheme storage unit in the fifth embodiment.

FIG. 12 is a schematic diagram illustrating a configuration example (third example) of the data stored in the encoding scheme storage unit in the fifth embodiment.

FIG. 13 is a schematic diagram illustrating a configuration example (fourth example) of the data stored in the encoding scheme storage unit in the fifth embodiment.

FIG. 14 is a block diagram illustrating a schematic functional configuration of a station building side apparatus (transmission apparatus) according to a sixth embodiment.

FIG. 15 is a block diagram illustrating a schematic functional configuration of a station building side apparatus (transmission apparatus) according to a seventh embodiment.

FIG. 16 is a block diagram illustrating a more detailed functional configuration for implementing functions of polarization separation, an adaptive filter, and modulation scheme identification in the station building side apparatus according to the seventh embodiment.

FIG. 17 is a block diagram illustrating a configuration of the adaptive filter included in the station building side apparatus according to the seventh embodiment.

FIG. 18 is a block diagram illustrating a functional configuration for modulation scheme identification included in a station building side apparatus according to an eighth embodiment.

### DESCRIPTION OF EMBODIMENTS

Hereinafter, a plurality of embodiments of the present invention will be described with reference to the drawings. Note that features of the plurality of embodiments described below may be appropriately combined and implemented as long as there is no contradiction regarding the combination.

### First Embodiment

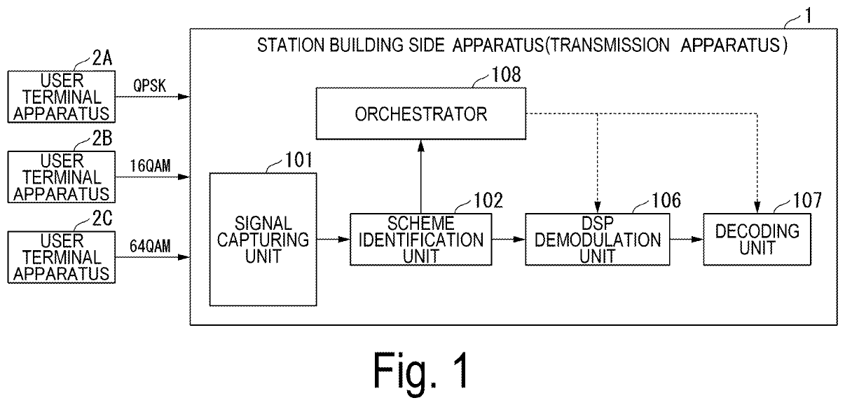

FIG. 1 is a block diagram illustrating a schematic functional configuration of a transmission apparatus (referred to as a station building side apparatus 1) according to a first embodiment. As illustrated, the station building side apparatus 1 includes a signal capturing unit 101, a scheme identification unit 102, a DSP demodulation unit 106, a decoding unit 107, and an orchestrator 108.

Each of functional units constituting the station building side apparatus 1 is configured using, for example, at least one of an optical circuit using an optical element or an electronic circuit using an electronic element. At least a part of functions of each of the functional units may be implemented by a computer (computation apparatus) and a program. In addition, at least a part of the functions of each of the functional units may be implemented as a dedicated electronic circuit or an optical circuit. Each of the functional units includes a storage means as necessary. As the storage means, for example, a semiconductor memory or an optical memory is used. In a case where a relatively slow information access speed is allowed, a magnetic disk apparatus may be used as the storage means.

The station building side apparatus 1 is, for example, an apparatus provided in a station building of a telecommunications carrier. The station building side device 1 performs communication with a user terminal apparatus 2. The station building side apparatus 1 can perform communication with a plurality of user terminal apparatuses 2 by respective different schemes. In the illustrated example, the station building side apparatus 1 performs communication with each of user terminal apparatuses 2A, 2B, and 2C. For example, the station building side apparatus 1 performs communication with the user terminal apparatus 2A by a modulation scheme of quadrature phase shift keying (QPSK). In addition, the station building side apparatus 1 performs communication with the user terminal apparatus 2B by a modulation scheme of 16 quadrature amplitude modulation (16QAM). In addition, the station building side apparatus 1 performs communication with the user terminal apparatus 2C by a modulation scheme of 64 quadrature amplitude modulation (64QAM). The station building side apparatus 1 may further performs communication with other user terminal apparatuses 2 at the same time. In addition, the station building side apparatus 1 may perform communication with those user terminal apparatuses 2 by using still other schemes. The modulation scheme with each of the user terminal apparatuses 2 can be determined on the basis of, for example, a request for a communication capacity for each user. Details of a signal processing method executed by the station building side apparatus 1 will be described below.

The signal capturing unit 101 captures a signal transmitted from a user terminal apparatus (2A, 2B, 2C, and the like) side. The signal is, for example, an optical signal. Note that the signal may be an electric signal or the like. The signal capturing unit 101 passes the captured signal to the scheme identification unit 102.

The scheme identification unit 102 infers and identifies a scheme of the received signal. The scheme here is a modulation scheme, a frame scheme (frame format), or an encoding scheme. That is, the scheme identification unit 102 identifies at least one of the modulation scheme, the frame format, or the encoding scheme on the basis of a characteristic of the received signal. The DSP demodulation unit 106 performs processing on the signal captured by the signal capturing unit 101. The DSP demodulation unit 106 specifically demodulates the signal. In addition, the DSP demodulation unit 106 detects a frame included in the signal.

The decoding unit 107 performs decoding processing on the frame detected by the DSP demodulation unit 106 described above.

The DSP demodulation unit 106 and the decoding unit 107 may be collectively referred to as a “signal processing unit”. That is, the signal processing unit processes the signal received by the station building side apparatus 1. Operation of the signal processing unit is controlled by the orchestrator 108 described below.

The orchestrator 108 performs control to cause a signal processing function to operate, the signal processing function depending on a result of identification of at least one of the modulation scheme, the frame format, or the encoding scheme by the scheme identification unit 102. The signal processing function here is a function for processing such as demodulation, frame detection, or decoding in the DSP demodulation unit 106 or the decoding unit 107 described above. The signal processing function has a variation depending on the result of identification of the scheme. Note that the orchestrator 108 is also referred to as a “function control unit”.

The orchestrator 108 activates the signal processing function (function of each of demodulation, frame detection, and decoding) depending on the result of identification by the scheme identification unit 102 and allocates a resource for the signal processing function to operate. The resource may include a memory or a computation apparatus.

The scheme identification unit 102 identifies the modulation scheme of the received signal on the basis of a frequency distribution of an amplitude of the received signal, for example. In addition, the scheme identification unit 102 identifies the frame format of the received signal on the basis of a bit string pattern of a preamble included in the received signal, for example. In addition, the scheme identification unit 102 performs a processing of demodulation of a code included in a frame detected from the received signal, and identifies the encoding scheme of the received signal on the basis of an amount of errors generated by the processing of demodulation, for example.

The orchestrator 108 performs control to cause a demodulation function to operate, the demodulation function depending on the modulation scheme identified by the scheme identification unit 102. In addition, the orchestrator 108 performs control to cause a frame detection function to operate, the frame detection function depending on the frame format identified by the scheme identification unit 102. In addition, the orchestrator 108 performs control to cause a decoding function to operate, the decoding function depending on the encoding scheme identified by the scheme identification unit 102.

The station building side apparatus 1 of the present embodiment configured with the above-described functions receives a signal. The scheme identification unit 102 infers and identifies the modulation scheme, the frame format (format), and the encoding scheme on the basis of the received signal. The DSP demodulation unit 106 demodulates the received signal on the basis of a result of above identification, and detects the frame. In addition, the decoding unit 107 performs decoding processing on the basis of the identified encoding scheme.

A parameter used when the scheme identification unit 102 identifies the modulation scheme, the frame format, or the encoding scheme is obtained by learning using the received signal. The scheme identification unit 102 stores the parameter. In addition, a parameter change unit (not illustrated) can appropriately rewrite the stored parameter. That is, for example, additional learning is performed on the basis of a signal received while the station building side apparatus 1 is in operation, whereby the parameter can be updated.

When identifying the frame format, the scheme identification unit 102 compares, for example, a pattern of a bit string of a preamble of the received frame with a predetermined pattern. Accordingly, the frame format can be identified.

In addition, the scheme identification unit 102 actually performs decoding processing on the basis of the detected frame, and identifies the encoding scheme on the basis of a rate of errors occurring at the time of the decoding processing. When decoding processing is performed on a plurality of encoding schemes, in a case where decoding is performed depending on an actually used encoding scheme, an error rate is extremely small as compared with other cases. As a result, the encoding scheme can be identified.

The scheme identification unit 102 identifies the modulation scheme and the frame format on the basis of a characteristic of a physical signal captured by the signal capturing unit 101. The orchestrator 108 receives information on the result of identification from the scheme identification unit 102. The orchestrator 108 causes a signal processing function (demodulation function, frame detection function, decoding function) suitable for the result of identification to operate on the basis of the received result of identification. That is, the orchestrator 108 performs control to change the signal processing function by designating a scheme and a processing data length on the basis of the received result of identification.

As processing before modulation scheme identification, the station building side apparatus 1 quantizes an amplitude of a received signal calculated by polarization separation processing in a multi-thread manner. In addition, the station building side apparatus 1 performs addition of an occurrence frequency (histogram information) to a bin of the quantized amplitude while performing exclusive control among a plurality of threads. In addition, the station building side apparatus 1 finally normalizes the histogram information to create an amplitude histogram of each of an X polarized wave and a Y polarized wave. This amplitude histogram represents a characteristic of the modulation scheme. That is, the scheme identification unit 102 identifies the modulation scheme on the basis of the amplitude histogram. Note that, details of preprocessing described here will be described later in a seventh embodiment.

To identify the modulation scheme, the station building side apparatus 1 may hold learning data corresponding to a plurality of optical signal to noise ratios (OSNRs) for each modulation scheme. The station building side apparatus 1 performs a nearest neighbor search between received data and the learning data on the basis of the learning data, and sets the nearest modulation scheme as a result of identification of the modulation scheme. The learning data will be described later in an eighth embodiment.

According to the present embodiment, one common station building side apparatus 1 (transmission apparatus) can implement various transmission functions. That is, it is possible to share one transmission apparatus in various transmission services.

In addition, the station building side apparatus 1 (transmission apparatus) of the present embodiment does not need to exchange a special frame format with a communication partner side when switching the transmission functions. That is, the station building side apparatus 1 (transmission apparatus) does not need to perform transmission and reception of a special sequence with an apparatus on the communication partner side for negotiation or the like when switching the transmission functions.

In addition, according to the station building side apparatus 1 (transmission apparatus) of the present embodiment, it is possible to identify the modulation scheme and the frame scheme with low computation. In addition, identification of those can be performed in real time. In addition, according to those transmission apparatuses, it is possible to implement identification processing corresponding to noise in a communication path while maintaining low computation.

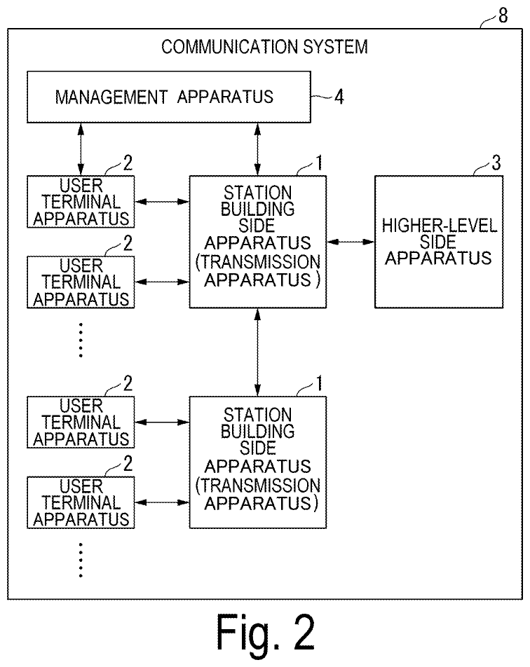

FIG. 2 is a block diagram illustrating a schematic apparatus configuration of a communication system configured using the station building side apparatus 1 of the present embodiment. As illustrated, for example, a communication system 8 includes a plurality of station building side apparatuses (transmission apparatuses) 1, a plurality of user terminal apparatuses 2, a higher-level side apparatus 3, and a management apparatus 4.

The station building side apparatus (transmission apparatus) 1 is an apparatus provided in a station building of a telecommunications carrier. The station building side apparatus 1 is connected to one or a plurality of user terminal apparatuses. In addition, the station building side apparatus 1 is also connected to another station building side apparatus 1. In addition, the station building side apparatus 1 is also connected to the higher-level side apparatus 3 on a higher-level network side.

The user terminal apparatus 2 is a terminal apparatus on a user side. When receiving a communication service, the user terminal apparatus 2 performs communication with the station building side apparatus 1. That is, the user terminal apparatus 2 transmits a signal encoded, framed, and modulated by a predetermined scheme to the station building side apparatus 1. In addition, conversely, the user terminal apparatus 2 receives a signal from the station building side apparatus 1.

The higher-level side apparatus 3 is an apparatus that belongs to a higher-level network of the telecommunications carrier, or an apparatus for the station building side apparatus 1 to access the higher-level network. The higher-level side apparatus 3 is connected to the station building side apparatus 1. In addition, the higher-level side apparatus 3 is also connected to another apparatus (not illustrated) on the higher-level network side.

The management apparatus 4 is a device having a function of managing communication between the station building side apparatus 1 and the user terminal apparatus 2. The management apparatus 4 passes a parameter necessary for identification of the modulation scheme or the encoding scheme to the station building side apparatus 1. In addition, in a case where the modulation scheme and the encoding scheme are identified on the user terminal apparatus 2 side, the management apparatus 4 passes parameters necessary for identification of the modulation scheme and the encoding scheme to the user terminal apparatus 2.

### Second Embodiment

Next, a second embodiment will be described. The second embodiment has a configuration according to a specific example (variation) for identification of the modulation scheme, identification of the frame, and identification of the decoding scheme in the configuration of the first embodiment. Note that the description of the matters already described in the previous embodiment may be omitted below. Here, matters specific to the present embodiment will be mainly described.

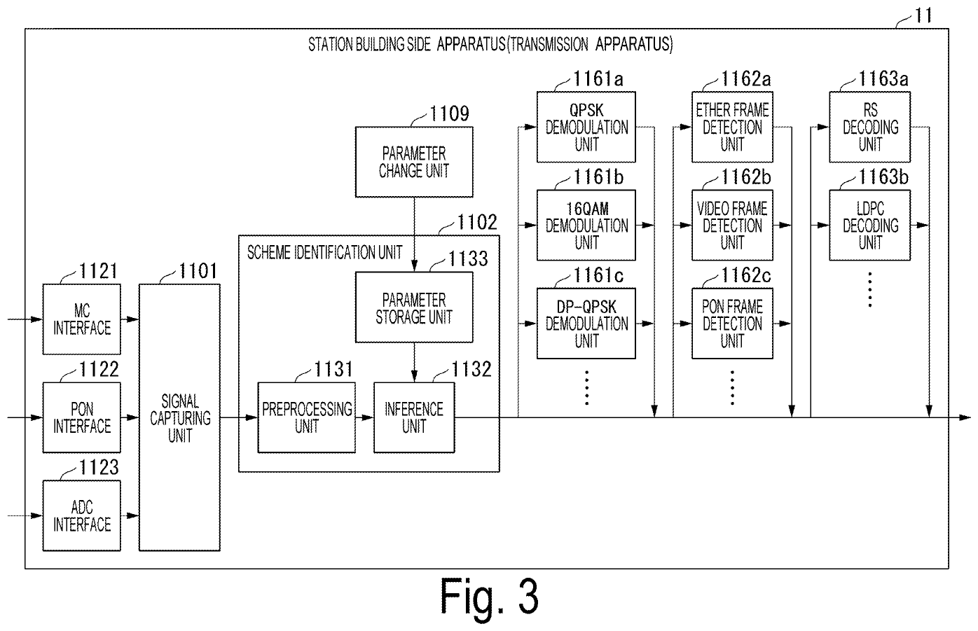

FIG. 3 is a block diagram illustrating a schematic functional configuration of a station building side apparatus (transmission apparatus) according to the present embodiment. As illustrated, a station building side apparatus (transmission apparatus) 11 includes an MC interface 1121, a PON interface 1122, an ADC interface 1123, a signal capturing unit 1101, a scheme identification unit 1102, a parameter change unit 1109, a QPSK demodulation unit 1161a, a 16QAM demodulation unit 1161b, a DP-QPSK demodulation unit 1161c, an Ether frame detection unit 1162a, a video frame detection unit 1162b, a PON frame detection unit 1162c, an RS decoding unit 1163a, and an LDPC decoding unit 1163b.

Each of the MC interface 1121, the PON interface 1122, and the ADC interface 1123 is an interface for receiving a signal from the user terminal apparatus 2 side. The MC interface 1121 is an interface of a media converter. The PON interface 1122 is an interface of a passive optical network (PON). The ADC interface 1123 is an interface based on an analog-to-digital converter (ADC). Note that the station building side apparatus 1 may further include another type of interface.

The signal capturing unit 1101 has a function of capturing a signal received via the interface such as the MC interface 1121, the PON interface 1122, or the ADC interface 1123. The signal capturing unit 1101 passes the received signal to the scheme identification unit 1102.

The scheme identification unit 1102 infers a format of the signal received via each interface. Specifically, the scheme identification unit 1102 infers the modulation scheme, the frame format, or the encoding scheme. The scheme identification unit 1102 notifies the orchestrator (see FIG. 1 of the first embodiment) of information on a result of inference (result of identification) of these. As a result, the orchestrator can cause a function suitable for the result of identification by the scheme identification unit 1102 to operate. Note that a more detailed functional configuration of the scheme identification unit 1102 is as illustrated, and will be described later.

The parameter change unit 1109 has a function of changing a parameter used by the scheme identification unit 1102 to identify the modulation scheme, the frame format, or the encoding scheme. The parameter change unit 1109 rewrites the parameter stored in the scheme identification unit 1102 on the basis of an instruction to change the parameter from the management apparatus 4 described in the first embodiment (see FIG. 2). As an example, the parameter change unit 1109 can change the parameter in a case where a variation of the received signal is changed, or the like.

The QPSK demodulation unit 1161a, the 16QAM demodulation unit 1161b, and the DP-QPSK demodulation unit 1161c demodulate signals modulated by modulation schemes of QPSK, 16QAM, and dual polarization differential quadrature phase shift keying (DP-QPSK), respectively. Note that the station building side apparatus (transmission apparatus) 11 may further have a demodulation function corresponding to a modulation scheme other than these. Information on the modulation scheme identified by the scheme identification unit 1102 on the basis of an input signal is passed to the orchestrator (see FIG. 1 of the first embodiment). The orchestrator appropriately selects and activates a demodulation function suitable for the identified modulation scheme. That is, when activation is performed by the orchestrator, each of the QPSK demodulation unit 1161a, the 16QAM demodulation unit 1161b, and the DP-QPSK demodulation unit 1161c demodulates the input signal of a corresponding scheme.

The Ether frame detection unit 1162a, the video frame detection unit 1162b, and the PON frame detection unit 1162c detect an Ether frame, a video frame, and a PON frame from the demodulated received signal, respectively. Note that the station building side apparatus (transmission apparatus) 11 may further have a function for detecting a frame of a format other than these. Information on the frame format identified by the scheme identification unit 1102 on the basis of the input signal is passed to the orchestrator (see FIG. 1). The orchestrator appropriately selects and activates a frame detection function suitable for the identified frame format. That is, when activation is performed by the orchestrator, each of the Ether frame detection unit 1162a, the video frame detection unit 1162b, and the PON frame detection unit 1162c detects a frame of each format.

The RS decoding unit 1163a and the LDPC decoding unit 1163b decode pieces of information encoded in an RS code and an LDPC code, respectively. Note that, the LDPC code is an abbreviation for a low-density parity check code. In addition, the RS code is an abbreviation of a Reed-Solomon code. Note that the station building side apparatus (transmission apparatus) 11 may further have a function for decoding information encoded by an encoding scheme other than these. Information on the encoding scheme identified by the scheme identification unit 1102 on the basis of the input signal is passed to the orchestrator (see FIG. 1). The orchestrator appropriately selects and activates a decoding function suitable for the identified encoding scheme. That is, when activation is performed by the orchestrator, each of the RS decoding unit 1163a and the LDPC decoding unit 1163b performs decoding processing by a corresponding scheme.

Here, a more detailed functional configuration of the scheme identification unit 1102 will be described. As illustrated in FIG. 3, the scheme identification unit 1102 includes a preprocessing unit 1131, an inference unit 1132, and a parameter storage unit 1133. Functions of these units are as follows.

The preprocessing unit 1131 performs preprocessing on information to be input to the scheme identification unit 1102. Specifically, the preprocessing unit 1131 outputs data suitable for processing performed by the inference unit 1132 by shaping an input signal (data).

The inference unit 1132 infers the modulation scheme, the frame format, or the encoding scheme on the basis of the data passed from the preprocessing unit 1131. The inference unit 1132 outputs identification information on the modulation scheme, identification information on the frame format, and identification information on the encoding scheme as a result of inference. The inference unit 1132 notifies the orchestrator (see FIG. 1) of the identification information on each of the modulation scheme, the frame format, and the encoding scheme. Note that the inference unit 1132 reads a necessary parameter value from the parameter storage unit 1133 and uses the parameter value when inferring the modulation scheme, the frame format, or the encoding scheme.

The parameter storage unit 1133 stores parameters necessary for inference processing performed by the inference unit 1132. These parameters may be rewritten by the parameter change unit 1109.

That is, the station building side apparatus (transmission apparatus) 11 of the present embodiment has the functional configuration as described above. As a result, the station building side apparatus (transmission apparatus) 11 acquires signals via various interfaces such as an MC, a PON, and an ADC. The signal capturing unit 1101 passes the captured signals to the scheme identification unit 1102.

### Third Embodiment

Next, a third embodiment will be described. The third embodiment has a configuration according to a specific example (variation) for identification of the modulation scheme, identification of the frame, and identification of the decoding scheme in the configuration of the first embodiment. Note that the description of the matters already described up to the previous embodiment may be omitted below. Here, matters specific to the present embodiment will be mainly described.

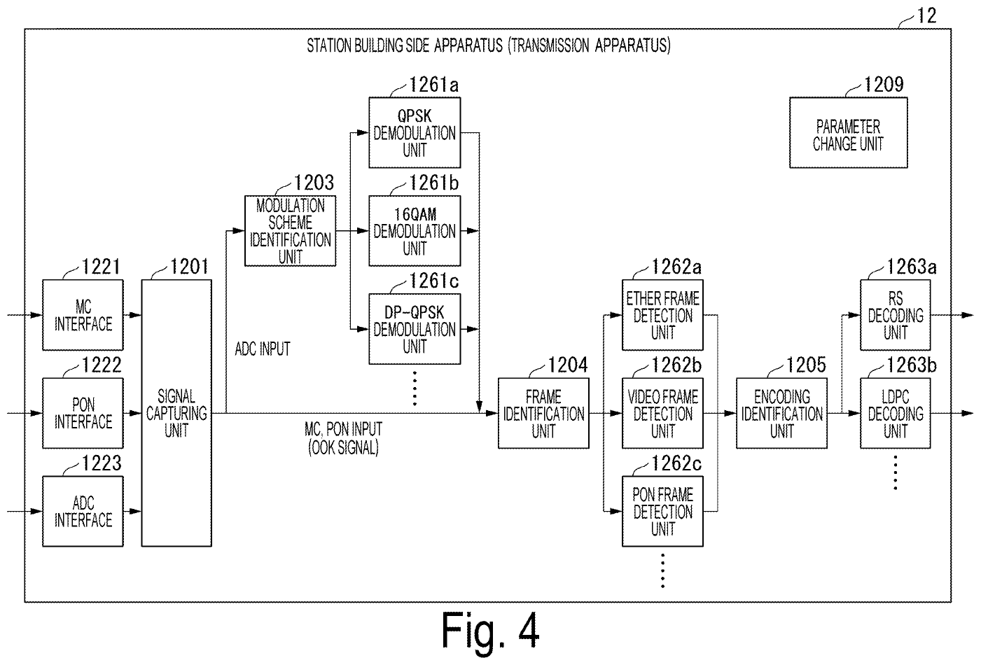

FIG. 4 is a block diagram illustrating a schematic functional configuration of a station building side apparatus (transmission apparatus) according to the present embodiment. As illustrated, a station building side apparatus (transmission apparatus) 12 includes an MC interface 1221, a PON interface 1222, an ADC interface 1223, a signal capturing unit 1201, a modulation scheme identification unit 1203, a QPSK demodulation unit 1261a, a 16QAM demodulation unit 1261b, a DP-QPSK demodulation unit 1261c, a frame identification unit 1204, an Ether frame detection unit 1262a, a video frame detection unit 1262b, a PON frame detection unit 1262c, an encoding identification unit 1205, an RS decoding unit 1263a, an LDPC decoding unit 1263b, and a parameter change unit 1209.

Note that the modulation scheme identification unit 1203, the frame identification unit 1204, and the encoding identification unit 1205 may be collectively referred to as a “scheme identification unit”. In addition, the QPSK demodulation unit 1261a, the 16QAM demodulation unit 1261b, the DP-QPSK demodulation unit 1261c, and the like may be collectively referred to as a “demodulation unit”. In addition, the Ether frame detection unit 1262a, the video frame detection unit 1262b, the PON frame detection unit 1262c, and the like may be collectively referred to as a “frame detection unit”. In addition, the RS decoding unit 1263a, the LDPC decoding unit 1263b, and the like may be collectively referred to as a “decoding unit”. In addition, the demodulation unit, the frame detection unit, and the decoding unit described above may be collectively referred to as a “signal processing unit”. These terms may be similar in other embodiments.

The feature of the present embodiment is that the station building side apparatus 12 includes the modulation scheme identification unit 1203, the frame identification unit 1204, and the encoding identification unit 1205. That is, the station building side apparatus 12 of the present embodiment includes functional units that estimate the modulation scheme, the frame format, and the encoding scheme, respectively.

The modulation scheme identification unit 1203 infers the modulation scheme for the signal received via the ADC interface 1223. The modulation scheme identification unit 1203 notifies the orchestrator (not illustrated) of the modulation scheme (for example, QPSK, 16QAM, DP-QPSK, or the like) that is a result of the identification.

The frame identification unit 1204 infers the frame format of the received signal. Specifically, for the signal received via the ADC interface 1223, the frame identification unit 1204 receives the demodulated signal and infers the frame format. In addition, for the received signal of ON/OFF modulation (signal received via the MC interface 1221, PON interface 1222, or the like), the frame identification unit 1204 directly receives the signal from the signal capturing unit 1201 and infers the frame format. The frame identification unit 1204 notifies the orchestrator (not illustrated) of the frame format (for example, Ether frame, video frame, PON frame, or the like) that is a result of the identification.

The encoding identification unit 1205 infers the encoding scheme for the frame detected from the received signal. The encoding identification unit 1205 notifies the orchestrator (not illustrated) of the encoding scheme (RS, LDPC, or the like) that is a result of the identification.

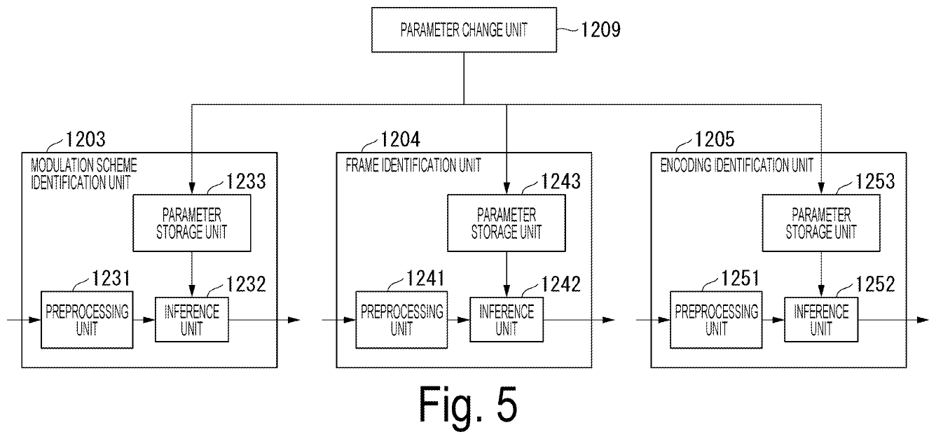

Note that an internal functional configuration of each of the modulation scheme identification unit 1203, the frame identification unit 1204, and the encoding identification unit 1205 will be described later with reference to FIG. 5.

The station building side apparatus 12 captures the signal received via the interface such as the MC interface 1221, the PON interface 1222, or the ADC interface 1223. Then, regarding the received signal via the ADC interface 1223, the modulation scheme identification unit 1203 infers the modulation scheme. When the modulation scheme identification unit 1203 reports the result of identification of the modulation scheme to the orchestrator, the orchestrator selects a demodulation function suitable for the modulation scheme and causes the demodulation function to operate. The demodulation function selected here is any one of the QPSK demodulation unit 1261a, the 16QAM demodulation unit 1261b, the DP-QPSK demodulation unit 1261c, and the like.

For a signal demodulated by any of the demodulation units or a signal (OOK signal) received by the interface (MC interface 1221, PON interface 1222, and the like) other than the ADC interface 1223, the frame identification unit 1204 identifies the frame format. Note that “OOK” is an abbreviation for “on-off-keying” (on-off modulation). When the frame identification unit 1204 reports the result of identification of the frame format to the orchestrator, the orchestrator selects a frame detection function suitable for the frame format and causes the frame detection function to operate. The frame detection function selected here is any of the Ether frame detection unit 1262a, the video frame detection unit 1262b, the PON frame detection unit 1262c, and the like.

After the frame is detected, the signal is input to the encoding identification unit 1205. The encoding identification unit 1205 infers the encoding scheme. When the encoding identification unit 1205 reports the result of identification of the encoding scheme to the orchestrator, the orchestrator selects a decoding function suitable for the encoding scheme and causes the decoding function to operate. The decoding function selected here is one of the RS decoding unit 1263a, the LDPC decoding unit 1263b, and the like. In this manner, the station building side apparatus 12 demodulates and decodes the received signal.

The MC interface 1221, the PON interface 1222, and the ADC interface 1223 are similar to the MC interface 1121, the PON interface 1122, and the ADC interface 1123 already described in the second embodiment, respectively. Note that the station building side apparatus 12 may include a communication interface other than these.

The signal capturing unit 1201 is similar to the signal capturing unit 1101 already described in the second embodiment. Note that the signal capturing unit 1201 of the present embodiment passes the signal received via the ADC interface 1223 to the modulation scheme identification unit 1203. In addition, the signal capturing unit 1201 does not pass the signal (OOK signal) received via the MC interface 1221, the PON interface 1222, or the like to the modulation scheme identification unit 1203 but directly passes the signal to the frame identification unit 1204.

In other words, the signal capturing unit 1201 passes, to the modulation scheme identification unit 1203, only the signal received via the interface based on the modulation scheme in which a constellation point is provided by shifting a phase.

As already described in the second embodiment, the QPSK demodulation unit 1261a, the 16QM demodulation unit 1261b, and the DP-QPSK demodulation unit 1261c demodulate the received signals modulated with QPSK, 16QAM, and DP-QPSK, respectively. Note that the station building side apparatus 12 may further has a function for demodulating a signal modulated with another scheme.

The Ether frame detection unit 1262a, the video frame detection unit 1262b, and the PON frame detection unit 1262c detect the Ether frame, the video frame, and the PON frame, respectively, as already described in the second embodiment. Note that the station building side apparatus 12 may further has a function for detecting a frame of another format.

The RS decoding unit 1263a and the LDPC decoding unit 1263b decode the RS code and the LDPC code, respectively, as already described in the second embodiment. Note that the station building side apparatus 12 may further has a function for decoding a code encoded with another scheme.

The parameter change unit 1209 changes the parameters stored in the modulation scheme identification unit 1203, the frame identification unit 1204, and the encoding identification unit 1205, respectively, as the parameter change unit 1109 in the second embodiment changes the parameters stored in the scheme identification unit 1102 (see also FIG. 5).

FIG. 5 is a schematic functional block diagram illustrating an internal functional configuration of each of the modulation scheme identification unit 1203, the frame identification unit 1204, and the encoding identification unit 1205 described in FIG. 4 above. As illustrated, the modulation scheme identification unit 1203 includes a preprocessing unit 1231, an inference unit 1232, and a parameter storage unit 1233. In addition, the frame identification unit 1204 includes a preprocessing unit 1241, an inference unit 1242, and a parameter storage unit 1243. In addition, the encoding identification unit 1205 includes a preprocessing unit 1251, an inference unit 1252, and a parameter storage unit 1253.

In the modulation scheme identification unit 1203, the preprocessing unit 1231 performs preprocessing on information to be input to the inference unit 1232. Specifically, the preprocessing unit 1231 outputs data suitable for processing performed by the inference unit 1132 by shaping an input signal (data).

In the modulation scheme identification unit 1203, the inference unit 1232 infers (identifies) the modulation scheme on the basis of the data passed from the preprocessing unit 1231. The inference unit 1232 outputs the identification information on the modulation scheme as a result of inference. The inference unit 1232 notifies the orchestrator of the identification information on the modulation scheme. Note that the inference unit 1232 reads a necessary parameter value from the parameter storage unit 1233 and uses the parameter value when inferring the modulation scheme.

In the modulation scheme identification unit 1203, the parameter storage unit 1233 stores a parameter necessary for processing performed by the inference unit 1232 to infer the modulation scheme. The parameter change unit 1209 can rewrite the parameter stored in the parameter storage unit 1233.

In the frame identification unit 1204, the preprocessing unit 1241 performs preprocessing on information to be input to the inference unit 1242. Specifically, the preprocessing unit 1241 outputs data suitable for processing performed by the inference unit 1142 by shaping an input signal (data).

In the frame identification unit 1204, the inference unit 1242 infers (identifies) the frame format on the basis of the data passed from the preprocessing unit 1241. The inference unit 1242 outputs identification information on the frame format as a result of inference. The inference unit 1242 notifies the orchestrator of the identification information on the frame format. Note that the inference unit 1242 reads a necessary parameter value from the parameter storage unit 1243 and uses the parameter value when inferring the frame format.

In the frame identification unit 1204, the parameter storage unit 1243 stores a parameter necessary for processing performed by the inference unit 1242 to infer the frame format. The parameter change unit 1209 can rewrite the parameter stored in the parameter storage unit 1243.

In the encoding identification unit 1205, the preprocessing unit 1251 performs preprocessing on information to be input to the inference unit 1252. Specifically, the preprocessing unit 1251 outputs data suitable for processing performed by the inference unit 1152 by shaping an input signal (data).

In the encoding identification unit 1205, the inference unit 1252 infers (identifies) the encoding scheme on the basis of the data passed from the preprocessing unit 1251. The inference unit 1252 outputs identification information on the encoding scheme as a result of inference. The inference unit 1252 notifies the orchestrator of the identification information on the encoding scheme. Note that the inference unit 1252 reads a necessary parameter value from the parameter storage unit 1253 and uses the parameter value when inferring the encoding scheme.

In the encoding identification unit 1205, the parameter storage unit 1253 stores a parameter necessary for processing performed by the inference unit 1242 to infer the encoding scheme. The parameter change unit 1209 can rewrite the parameter stored in the parameter storage unit 1253.

As described above, with the configuration illustrated in FIG. 5, the modulation scheme identification unit 1203 identifies the modulation scheme and reports the information on a result of the identification to the orchestrator. As a result, the orchestrator can cause a demodulation function suitable for the result of identification to operate. In addition, the frame identification unit 1204 identifies the frame format and reports information on a result of the identification to the orchestrator. As a result, the orchestrator can cause a frame detection function suitable for the result of identification to operate. In addition, the encoding identification unit 1205 identifies the encoding scheme and reports information on a result of the identification to the orchestrator. As a result, the orchestrator can cause a decoding function suitable for the result of identification to operate.

### Fourth Embodiment

Next, a fourth embodiment will be described. The fourth embodiment has a configuration according to a specific example (variation) for identification of the modulation scheme, identification of the frame, and identification of the decoding scheme in the configuration of the first embodiment. Note that the description of the matters already described up to the previous embodiment may be omitted below. Here, matters specific to the present embodiment will be mainly described.

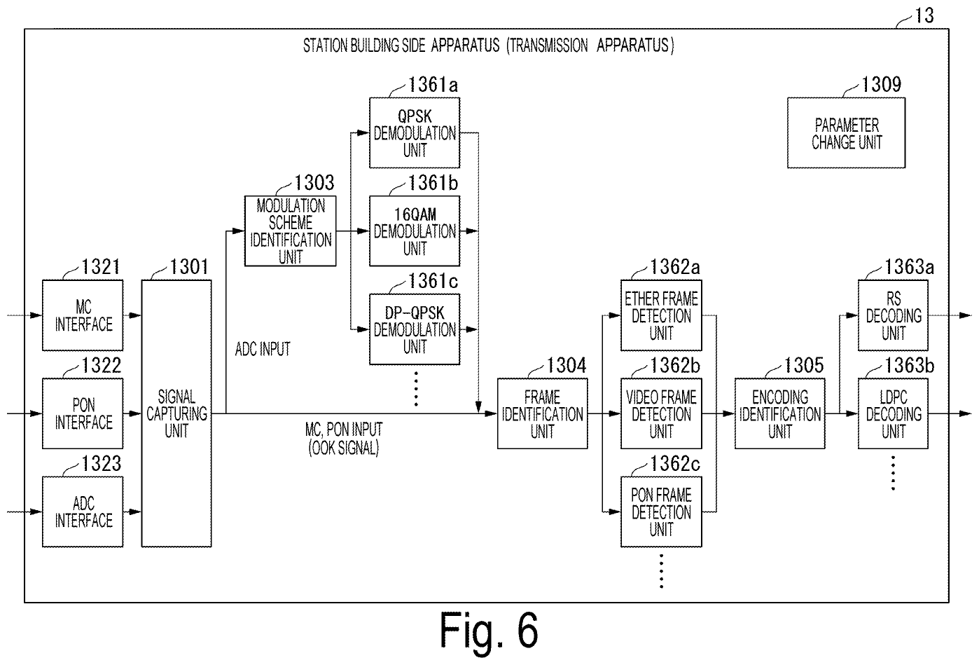

FIG. 6 is a block diagram illustrating a schematic functional configuration of a station building side apparatus (transmission apparatus) according to the present embodiment. As illustrated, a station building side apparatus (transmission apparatus) 13 includes an MC interface 1321, a PON interface 1322, an ADC interface 1323, a signal capturing unit 1301, a modulation scheme identification unit 1303, a QPSK demodulation unit 1361a, a 16QAM demodulation unit 1361b, a DP-QPSK demodulation unit 1361c, a frame identification unit 1304, an Ether frame detection unit 1362a, a video frame detection unit 1362b, a PON frame detection unit 1362c, an encoding identification unit 1305, an RS decoding unit 1363a, an LDPC decoding unit 1363b, and a parameter change unit 1309.

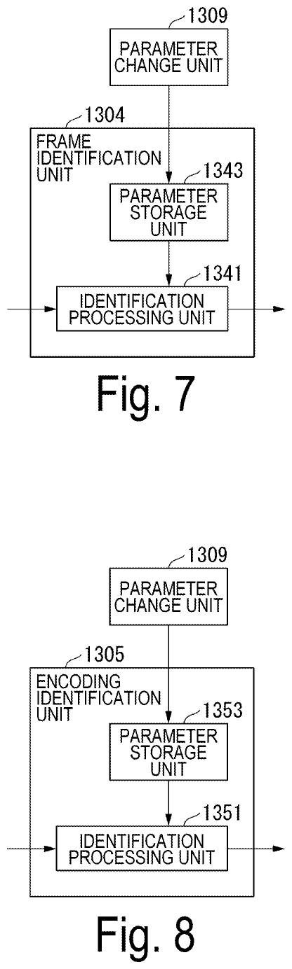

One of features of the station building side apparatus 13 of the present embodiment is how the frame identification unit 1304 is implemented. In addition, another feature of the station building side apparatus 13 is how the encoding identification unit 1305 is implemented. These will be described next with reference to FIGS. 6 and 7, respectively. Note that only one of the frame identification unit 1304 or the encoding identification unit 1305 of the present embodiment may be implemented. In a case where only the frame identification unit 1304 is implemented, the configuration described in another embodiment may be used as the function for identifying the encoding scheme. In a case where only the encoding identification unit 1305 is implemented, the configuration described in another embodiment may be used as the function for identifying the frame format.

FIG. 7 is a block diagram illustrating a schematic functional configuration of a frame identification unit according to the present embodiment. As illustrated, the frame identification unit 1304 includes an identification processing unit 1341 based on comparison of bit strings of preambles and a parameter storage unit 1343.

The identification processing unit 1341 of the present embodiment identifies the frame format by comparing bit strings of preambles. Specifically, the identification processing unit 1341 compares a preamble of the received signal with a preamble of a frame of each format stored in advance. Specifically, the identification processing unit 1341 compares the preamble of the received signal with a preamble of the Ethernet frame, the video frame, the PON frame, or the like (or may be a frame of another format). The identification processing unit 1341 identifies that a matched type of frame is in the frame format of the actual received signal. In a case where such a method of the identification processing unit 1341 is used, although an amount of computation is larger than that of the method in the second embodiment or the third embodiment, it is possible to more accurately identify the frame format.

The parameter storage unit 1343 stores a parameter to be referred to in identification processing by the identification processing unit 1341 described above. The parameter storage unit 1343 may store bit string patterns of preambles in various frame formats. Data stored in the parameter storage unit 1343 may be rewritten by the parameter change unit 1309.

With the above configuration, the frame identification unit 1304 identifies the frame format of the received signal on the basis of the bit string pattern of the preamble included in the received signal.

FIG. 8 is a block diagram illustrating a schematic functional configuration of an encoding identification unit according to the present embodiment. As illustrated, the encoding identification unit 1305 includes an identification processing unit 1351 based on decoding and a parameter storage unit 1353.

The identification processing unit 1351 of the present embodiment identifies the encoding scheme by actually performing decoding processing by a plurality of schemes. The identification processing unit 1351 performs different types of decoding processing such as RS decoding, LDPC decoding, and the like (may further include decoding by another scheme) with a fixed code length, for example. The identification processing unit 1351 identifies the encoding scheme having a small number of errors of the received signal obtained by those types of decoding processing as an encoding scheme of the actually received signal. In addition, the identification processing unit 1351 may identify the encoding scheme of the actually received signal by performing error correction processing at the time of decoding and determining a redundancy at which error correction is possible. In a case where such a method of the identification processing unit 1351 is used, although the amount of computation is larger than that of the method in the second embodiment or the third embodiment, it is possible to more accurately identify the encoding scheme.

The parameter storage unit 1353 stores a parameter to be referred to in identification processing by the identification processing unit 1351 described above. Data stored and held in the parameter storage unit 1353 may be rewritten by the parameter change unit 1309.

With the above configuration, the encoding identification unit 1305 performs processing of demodulating the code included in the frame detected from the received signal, and identifies the encoding scheme of the received signal on the basis of the amount of errors generated by the processing of demodulation.

As other functions (functions whose description is omitted in the present embodiment) of the station building side apparatus (transmission apparatus) 13, the same functions as those described in the other embodiments can be used.

### Fifth Embodiment

Next, a fifth embodiment will be described. The fifth embodiment has a configuration according to a specific example (variation) for identification of the modulation scheme, identification of the frame, and identification of the decoding scheme in the configuration of the first embodiment. Note that the description of the matters already described up to the previous embodiment may be omitted below. Here, matters specific to the present embodiment will be mainly described.

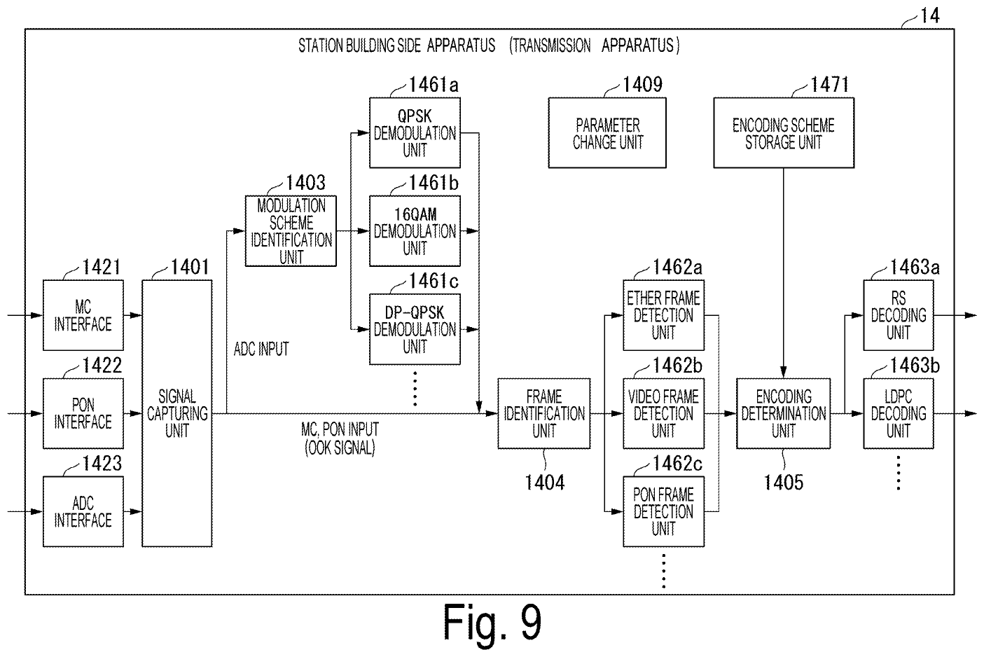

FIG. 9 is a block diagram illustrating a schematic functional configuration of a station building side apparatus (transmission apparatus) according to the present embodiment. As illustrated, a station building side apparatus (transmission apparatus) 14 includes an MC interface 1421, a PON interface 1422, an ADC interface 1423, a signal capturing unit 1401, a modulation scheme identification unit 1403, a QPSK demodulation unit 1461a, a 16QAM demodulation unit 1461b, a DP-QPSK demodulation unit 1461c, a frame identification unit 1404, an Ether frame detection unit 1462a, a video frame detection unit 1462b, a PON frame detection unit 1462c, an encoding determination unit 1405, an RS decoding unit 1463a, an LDPC decoding unit 1463b, a parameter change unit 1409, and an encoding scheme storage unit 1471.

Features of the station building side apparatus 14 according to the present embodiment lies in the encoding determination unit 1405 and the encoding scheme storage unit 1471. In the present embodiment, processing after the station building side apparatus 14 detects a frame is performed on the basis of a frame type, user identification information, user attribute information, or the like. Specifically, the processing is performed as follows.

The encoding scheme storage unit 1471 stores a relationship between information acquired by the station building side apparatus 14 in processing up to frame detection and the encoding scheme. Specifically, the encoding scheme storage unit 1471 stores, for example, a correspondence between the frame format and the encoding scheme. Alternatively, the encoding scheme storage unit 1471 stores, for example, a correspondence between user identification information (ID) that can be acquired from the detected frame and the encoding scheme. Alternatively, the encoding scheme storage unit 1471 may store, for example, a correspondence between a user attribute (identification information on a set to which the user belongs, or the like) specified by the user identification information and the encoding scheme. Alternatively, the encoding scheme storage unit 1471 may store, for example, a correspondence between information on a type of the user terminal apparatus 2 that can be acquired from the detected frame and the encoding scheme.

The encoding determination unit 1405 determines the encoding scheme by referring to the encoding scheme storage unit 1471 on the basis of information that can be acquired from the detected frame. For example, the encoding determination unit 1405 acquires the frame type (identification information on the frame format) identified by the frame identification unit 1404, and reads the encoding scheme corresponding to the type from the encoding scheme storage unit 1471. Alternatively, the encoding determination unit 1405 reads user identification information embedded in, for example, a portion of the preamble in the detected frame. Then, the encoding determination unit 1405 reads the encoding scheme corresponding to the user identification information from the encoding scheme storage unit 1471. Alternatively, the encoding determination unit 1405 determines attribute information on the user on the basis of the read user identification information. Then, the encoding determination unit 1405 reads the encoding scheme corresponding to the user attribute from the encoding scheme storage unit 1471. Alternatively, the encoding determination unit 1405 reads user terminal apparatus type information embedded in, for example, a portion of the preamble in the detected frame. Then, the encoding determination unit 1405 reads the encoding scheme corresponding to the user terminal apparatus type information from the encoding scheme storage unit 1471.

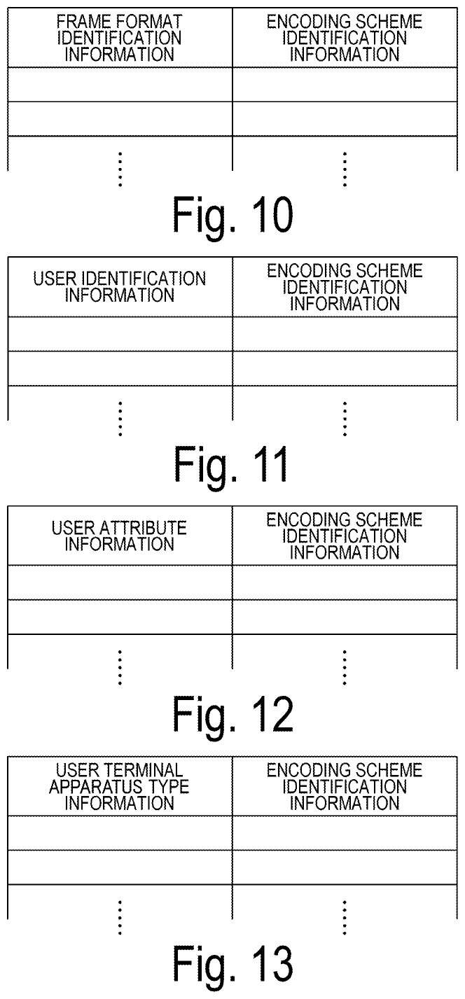

FIGS. 10, 11, 12, and 13 are schematic diagrams each illustrating an example of a configuration of data stored in the encoding scheme storage unit 1471. As illustrated, the encoding scheme storage unit 1471 stores, as tabular data, a correspondence between information that can be acquired by the station building side apparatus 14 by processing up to frame detection and encoding scheme identification information. In the case of the example of FIG. 10, the encoding scheme storage unit 1471 stores a correspondence between frame format identification information and the encoding scheme identification information. In the example of FIG. 11, the encoding scheme storage unit 1471 stores a correspondence between the user identification information and the encoding scheme identification information. In the example of FIG. 12, the encoding scheme storage unit 1471 stores a correspondence between the user attribute information and the encoding scheme identification information. In the example of FIG. 13, the encoding scheme storage unit 1471 stores a correspondence between the user terminal apparatus type information and the encoding scheme identification information.

Note that the encoding scheme storage unit 1471 may store a correspondence between information other than the above (however, information that can be acquired by the station building side apparatus 14 before processing at a stage of frame detection) and the encoding scheme identification information. In this case, the encoding determination unit 1405 refers to a table of the encoding scheme storage unit 1471 on the basis of the information that has been acquired, and reads the encoding scheme identification information.

The encoding determination unit 1405 determines the encoding scheme by any of the methods described above. As a result, the station building side apparatus 14 can perform decoding processing depending on the encoding scheme obtained as a result of determination.

### Sixth Embodiment

Next, a sixth embodiment will be described. The sixth embodiment is a form according to a configuration in which the station building side apparatus includes an orchestrator. Note that the description of the matters already described up to the previous embodiment may be omitted below. Here, matters specific to the present embodiment will be mainly described.

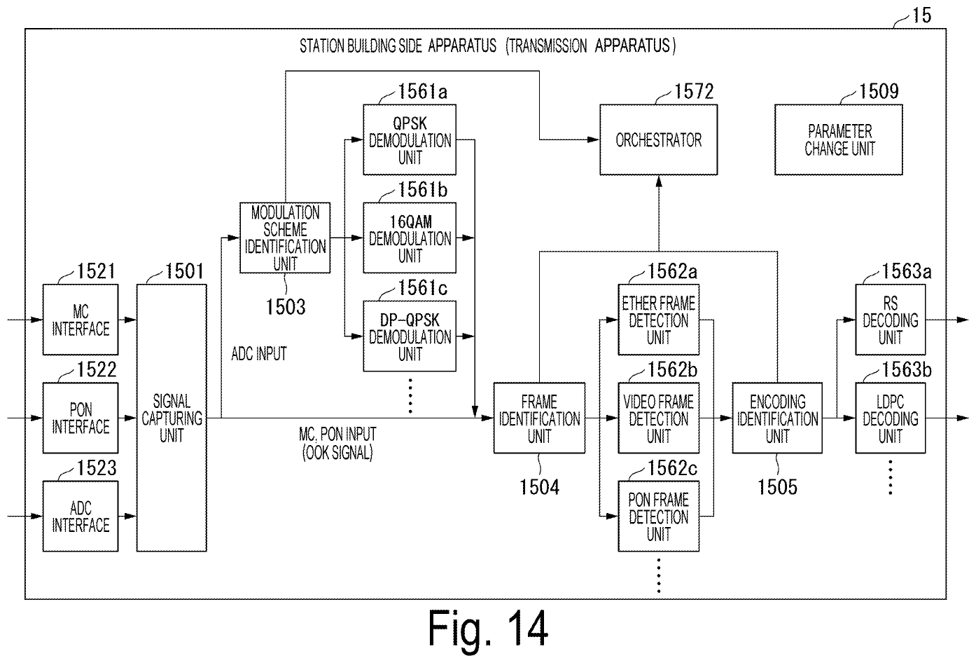

FIG. 14 is a block diagram illustrating a schematic functional configuration of a station building side apparatus (transmission apparatus) according to the present embodiment. As illustrated, a station building side apparatus (transmission apparatus) 15 includes an MC interface 1521, a PON interface 1522, an ADC interface 1523, a signal capturing unit 1501, a modulation scheme identification unit 1503, a QPSK demodulation unit 1561a, a 16QAM demodulation unit 1561b, a DP-QPSK demodulation unit 1561c, a frame identification unit 1504, an Ether frame detection unit 1562a, a video frame detection unit 1562b, a PON frame detection unit 1562c, an encoding identification unit 1505, an RS decoding unit 1563a, an LDPC decoding unit 1563b, a parameter change unit 1509, and an orchestrator 1572.

The orchestrator 1572 that is a feature of the present embodiment corresponds to the orchestrator 108 described in FIG. 1. Note that the orchestrator 1572 is also referred to as a “function control unit”. The orchestrator 1572 manages and controls switching of functions in the station building side apparatus 15 depending on a result of identification of the modulation scheme, the frame format, or the encoding scheme.

Specifically, the orchestrator 1572 performs control to cause functions to operate, the functions depending on the respective results of identification of the modulation scheme, the frame format, and the encoding scheme. That is, the orchestrator 1572 activates functions required depending on the results of identification, and allocates resources (calculation resources) necessary for those functions to operate.

That is, the orchestrator 1572 receives a report on the result of identification of the modulation scheme from the modulation scheme identification unit 1503. The orchestrator 1572 causes any one of the QPSK demodulation unit 1561a, the 16QAM demodulation unit 1561b, the DP-QPSK demodulation unit 1561, and the like (may be other than the functions exemplified herein) to appropriately operate depending on the result of identification of the modulation scheme, and allocates a resource therefor. In addition, the orchestrator 1572 receives a report on the result of identification of the frame format from the frame identification unit 1504. The orchestrator 1572 causes any one of the Ether frame detection unit 1562a, the video frame detection unit 1562b, the PON frame detection unit 1562c, and the like (may be other than the functions exemplified herein) to appropriately operate depending on the result of identification of the frame format, and allocates a resource therefor. In addition, the orchestrator 1572 receives a report on the result of identification of the encoding scheme from the encoding identification unit 1505. The orchestrator 1572 causes any one of the RS decoding unit 1563a, the LDPC decoding unit 1563b, and the like (may be other than the functions exemplified herein) to appropriately operate depending on the result of identification of the encoding scheme, and allocates a resource therefor.

Note that the modulation scheme identification unit 1503 notifies the orchestrator 1572 of information on the result of identification of the modulation scheme by the modulation scheme identification unit 1503 itself so that the orchestrator 1572 can perform the above-described function control. In addition, the frame identification unit 1504 notifies the orchestrator 1572 of information on the result of identification of the frame format by the frame identification unit 1504 itself. In addition, the encoding identification unit 1505 notifies the orchestrator 1572 of information on the result of identification of the encoding scheme by the encoding identification unit 1505 itself.

An example of operation of the orchestrator is as follows. For example, when determining that the received signal is a signal modulated by the QPSK scheme, an inference unit inside the modulation scheme identification unit 1503 reports a result of the identification to the orchestrator 1572.

The orchestrator 1572 activates the function of the QPSK demodulation unit 1561a for demodulating the reported QPSK scheme signal. In addition, the orchestrator 1572 secures a memory necessary for the QPSK demodulation unit 1561a to function. Then, the orchestrator 1572 notifies (the inference unit or the like of) the QPSK demodulation unit 1561a of an address of the memory, and causes the signal to be processed to be directed to the QPSK demodulation unit 1561a. The same applies to demodulation units of other schemes. In addition, the same applies to each frame detection unit. In addition, the same applies to each decoding unit.

The orchestrator 1572 of the present embodiment causes a function to operate corresponding to the result of identification of the modulation scheme, the frame format, or the encoding scheme as described above.

### Seventh Embodiment

Next, the seventh embodiment will be described. The seventh embodiment describes an example of a more detailed configuration particularly for identifying the modulation scheme. The configuration of the present embodiment is an example of a configuration for enabling processing of identifying the modulation scheme to be executed in real time. Note that the description of the matters already described up to the previous embodiment may be omitted below. Here, matters specific to the present embodiment will be mainly described.

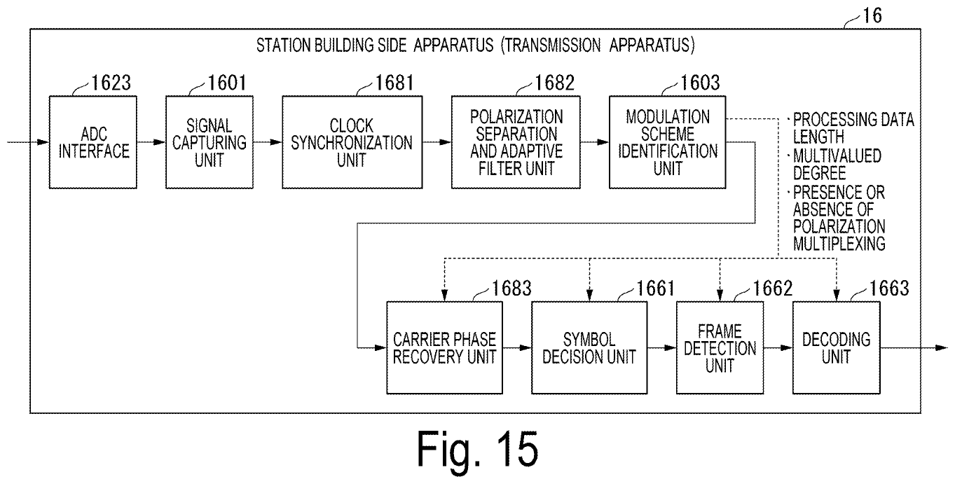

FIG. 15 is a block diagram illustrating a schematic functional configuration of a station building side apparatus (transmission apparatus) according to the present embodiment. As illustrated, a station building side apparatus (transmission apparatus) 16 includes an ADC interface 1623, a signal capturing unit 1601, a clock synchronization unit 1681, a polarization separation and adaptive filter unit 1682, a modulation scheme identification unit 1603, a carrier phase recovery unit 1683, a symbol decision unit 1661, a frame detection unit 1662, and a decoding unit 1663. Note that FIG. 15 illustrates only a configuration of a case where a signal is received by the ADC interface 1623, and omits a configuration for signal reception by the MC interface or the PON interface. The signal reception by the MC interface or the PON interface is as described in other embodiments.

The ADC interface 1623 is an interface for receiving a signal by an ADC.

The signal capturing unit 1601 captures a received signal via the ADC interface 1623.

The clock synchronization unit 1681 synchronizes the received signal with a clock signal for processing in the station building side apparatus 16.

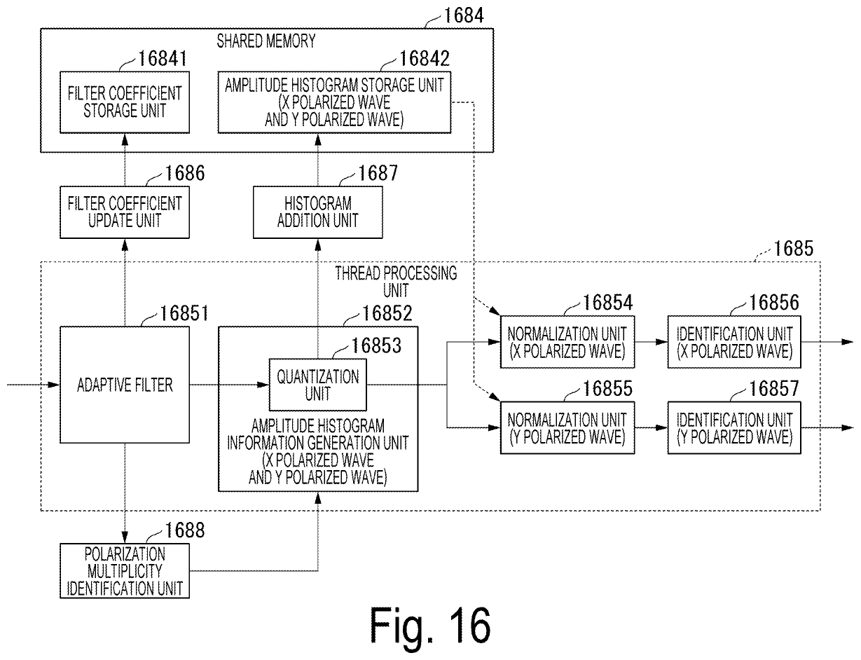

The polarization separation and adaptive filter unit 1682 and the modulation scheme identification unit 1603 identify the modulation scheme for the received signal. Processing performed by the polarization separation and adaptive filter unit 1682 is preprocessing for identifying the modulation scheme. More detailed configurations of the polarization separation and adaptive filter unit 1682 and the modulation scheme identification unit 1603 will be described later with reference to FIG. 16. As described later, the modulation scheme identification unit 1603 identifies the modulation scheme of the received signal on the basis of a frequency distribution of an amplitude of the received signal.

As a result of the processing by the modulation scheme identification unit 1603, information is obtained on a processing data length, a multivalued degree, and presence or absence of polarization multiplexing. The modulation scheme identification unit 1603 passes the information on the processing data length, the multivalued degree, and the presence or absence of polarization multiplexing to the carrier phase recovery unit 1683, the symbol decision unit 1661, the frame detection unit 1662, and the decoding unit 1663.

The carrier phase recovery unit 1683 evaluates a frequency shift and a phase shift to recover an input waveform of the received signal.

The symbol decision unit 1661 determines a symbol included in the received signal on the basis of the signal recovered by the carrier phase recovery unit 1683.

The frame detection unit 1662 detects a frame as described in other embodiments.

As described in other embodiments, the decoding unit 1663 decodes a code included in the detected frame.

FIG. 16 is a functional block diagram illustrating more detailed functional configurations of the polarization separation and adaptive filter unit 1682 and the modulation scheme identification unit 1603 of the present embodiment. As illustrated, the function includes a thread processing unit 1685, a polarization multiplicity identification unit 1688, a shared memory 1684, a filter coefficient update unit 1686, and a histogram addition unit 1687. The function performs processing in a multi-thread manner. As illustrated, the processing of identifying the modulation scheme is executed at a stage after polarization separation and an adaptive filter.

The thread processing unit 1685 performs processing in units of threads of an input signal, and includes an adaptive filter 16851, an amplitude histogram information generation unit 16852, a normalization unit (X polarized wave) 16854, a normalization unit (Y polarized wave) 16855, an identification unit (X polarized wave) 16856, and an identification unit (Y polarized wave) 16857. The station building side apparatus 16 has a configuration of the thread processing unit 1685 for each thread. Note that the amplitude histogram information generation unit 16852 includes a quantization unit 16853.

The shared memory 1684 stores information necessary for processing of the function. Specifically, the shared memory 1684 includes a filter coefficient storage unit 16841 and an amplitude histogram storage unit 16842.

The filter coefficient storage unit 16841 stores filter coefficients of the adaptive filter 16851. As described later, the adaptive filter 16851 has filter coefficients Pₓₓ, P_{xy}, P_{yx}, and P_{yy}. The filter coefficient storage unit 16841 stores these coefficients Pₓₓ, P_{xy}, P_{yx}, and P_{yy}. The filter coefficient storage unit 16841 on the shared memory 1684 is updated by the filter coefficient update unit 1686.

The amplitude histogram storage unit 16842 stores information on an amplitude histogram for identifying the modulation scheme. The amplitude histogram for the X polarized wave is hₓ. In addition, the amplitude histogram for the Y polarized wave is h_{y}. However, in a case where the received signal is a unidirectional modulation signal, the amplitude histogram storage unit 16842 may store amplitude histogram information only for the unidirectional polarized wave. Each of hₓ and h_{y} has frequency information for each bin. Each of hₓ and h_{y} can be expressed, for example, as vector data. A frequency of one bin is expressed as hₓ (bin), h_{y} (bin), or the like.

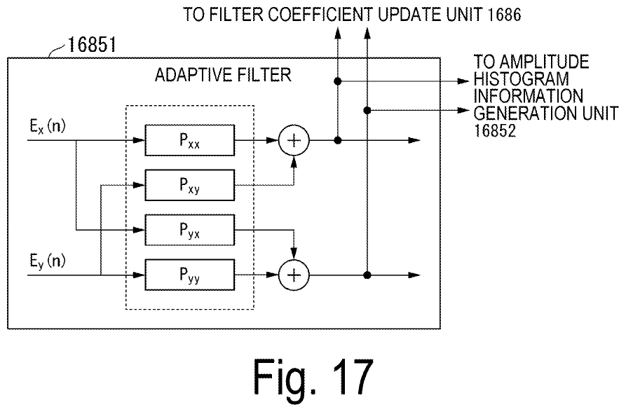

The adaptive filter 16851 is a filter having a configuration illustrated in FIG. 17. The adaptive filter 16851 performs computation based on the filter coefficients Pₓₓ, P_{xy}, P_{yx}, and P_{yy}. These filter coefficients are read from the filter coefficient storage unit 16841.

The filter coefficient update unit 1686 updates the filter coefficients stored in the filter coefficient storage unit 16841 of the shared memory 1684. Note that the filter coefficient update unit 1686 updates the filter coefficients on the basis of data from a plurality of the thread processing units 1685. The filter coefficient update unit 1686 updates the filter coefficients while performing exclusive control between threads so that a collision of data update between threads does not occur.

Note that the filter coefficient update unit 1686 updates the filter coefficients by Formula (1) below.

$$\begin{matrix}[ Math . 1 ] & \\ {p}_{x x} ( n + 1 ) = {p}_{x x} ( n ) + μ ( {R}_{X} - {\vert {E}_{X} ( n ) \vert}^{2} ) {E}_{X} ( n ) {E}_{x}^{*} ( n ) {p}_{x y} ( n + 1 ) = {p}_{x y} ( 𝔫 ) + μ ( {R}_{X} - {\vert {E}_{X} ( n ) \vert}^{2} ) {E}_{X} ( n ) {E}_{y}^{*} ( n ) {p}_{y x} ( n + 1 ) = {p}_{y x} ( n ) + μ ( {R}_{Y} - {\vert {E}_{Y} ( n ) \vert}^{2} ) {B}_{Y} ( n ) {E}_{x}^{*} ( n ) {p}_{y y} ( n + 1 ) = {p}_{y y} ( n ) + μ ( {R}_{Y} - {\vert {E}_{Y} ( n ) \vert}^{2} ) {E}_{Y} ( n ) {E}_{y}^{*} ( n ) & ( 1 )\end{matrix}$$

The polarization multiplicity identification unit 1688 determines whether or not polarization multiplexing is performed on the basis of a signal output from the adaptive filter 16851. The polarization multiplicity identification unit 1688 passes information on a result of the determination to the amplitude histogram information generation unit 16852.

The amplitude histogram information generation unit 16852 generates amplitude histogram information regarding the received signal and passes the amplitude histogram information to the histogram addition unit 1687. In a case where both the X polarized wave and the Y polarized wave are modulated signals according to the information from the polarization multiplicity identification unit 1688, the amplitude histogram information generation unit 16852 generates amplitude histogram information for each of the X polarized wave and the Y polarized wave. In the case of the unidirectional modulation signal, the amplitude histogram information generation unit 16852 generates amplitude histogram information only for the unidirectional polarized wave. The generation of the histogram information by the amplitude histogram information generation unit 16852 is preprocessing for identifying the modulation scheme.

The amplitude histogram information generation unit 16852 includes the quantization unit 16853 therein. The quantization unit 16853 quantizes a received signal amplitude in the polarization separation. The amplitude histogram information generation unit 16852 generates information for adding the occurrence frequency for a determined bin as a result of quantization by the quantization unit 16853 for each thread. The amplitude histogram information generation unit 16852 passes the generated histogram information to the histogram addition unit 1687.

The histogram addition unit 1687 sequentially adds a frequency of a detected amplitude to the amplitude histogram on the basis of the information passed from the amplitude histogram information generation unit 16852. Note that the histogram addition unit 1687 adds the histogram information on the basis of data from the plurality of thread processing units 1685. The histogram addition unit 1687 updates the filter coefficients while performing exclusive control between threads so that a collision of data update between threads does not occur.

The histogram addition unit 1687 adds the amplitude histogram information for each of the X polarized wave and the Y polarized wave in a case where polarization multiplexing is performed, on the basis of the result of identification by the polarization multiplicity identification unit 1688. In addition, in the case of the unidirectional modulation signal, the histogram addition unit 1687 adds the amplitude histogram information only for the unidirectional polarized wave.

Processing of adding the frequency information for each bin by the histogram addition unit 1687 is expressed by Formula (2) below for the X polarized wave and Formula (3) below for the Y polarized wave.

$$\begin{matrix}[ Math . 2 ] & \\ {h}_{X} ( bin ) = {h}_{X} ( bin ) + 1 & ( 2 )\end{matrix}$$

$$\begin{matrix}[ Math . 3 ] & \\ {h}_{Y} ( bin ) = {h}_{Y} ( bin ) + 1 & ( 3 )\end{matrix}$$

The normalization unit (X polarized wave) 16854 reads the histogram of the X polarized wave from the amplitude histogram storage unit 16842 and normalizes the histogram.

The normalization unit (Y polarized wave) 16855 reads the histogram of the X-polarized wave from the amplitude histogram storage unit 16842 and normalizes the histogram.

The identification unit (X polarized wave) 16856 identifies the modulation scheme of the X polarized wave on the basis of the normalized histogram of the X polarized wave.

The identification unit (Y polarized wave) 16857 identifies the modulation scheme of the Y polarized wave on the basis of the normalized histogram of the Y polarized wave.

Note that, in a case where the received signal is a unidirectional modulation signal, only one of the identification unit (X polarized wave) 16856 or the identification unit (Y polarized wave) 16857 needs to identify the modulation scheme. In the identification processing, each of the identification unit (X polarized wave) 16856 and the identification unit (Y polarized wave) 16857 can use methods such as convolutional neural network (CNN), approximate nearest neighbor search, neighborhood search, and detection based on the number of extreme values of the histogram.

With the configuration described above, the station building side apparatus 16 according to the present embodiment can identify the modulation scheme in real time.

### Eighth Embodiment

Next, the eighth embodiment will be described. The eighth embodiment describes an example of a more detailed configuration particularly for identifying the modulation scheme. The configuration of the present embodiment is an example of a configuration for enabling processing of identifying the modulation scheme to be executed in real time. Note that the description of the matters already described up to the previous embodiment may be omitted below. Here, matters specific to the present embodiment will be mainly described.

The present embodiment is one form of an implementation method for the identification unit (X polarized wave) 16856 and the identification unit (Y polarized wave) 16857 in the modulation scheme identification processing described in the seventh embodiment.

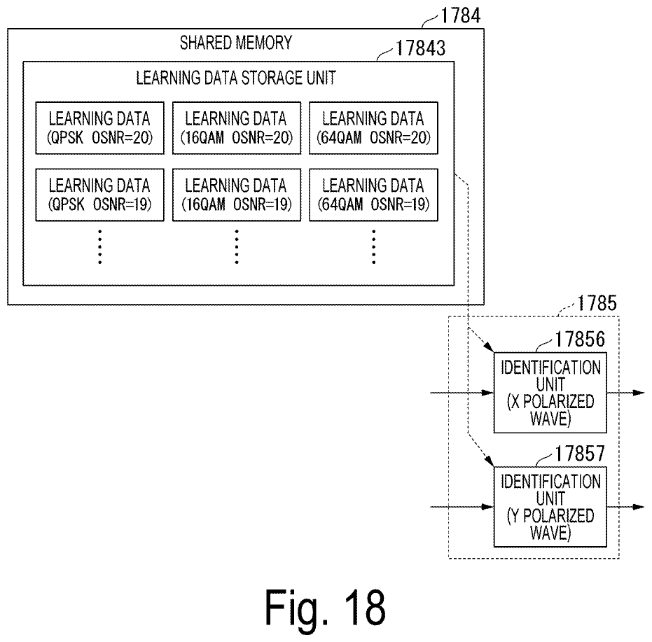

FIG. 18 is a block diagram illustrating a functional configuration for modulation scheme identification included in a station building side apparatus according to the present embodiment. As illustrated, a station building side apparatus 17 includes a shared memory 1784 and an identification unit 1785. The shared memory 1784 includes a learning data storage unit 17843. In addition, the identification unit 1785 includes an identification unit (X polarized wave) 17856 and an identification unit (Y polarized wave) 17857. Configurations of other functions of the station building side apparatus 17 are not illustrated, but may be similar to those described in other embodiments.

In the present embodiment, the learning data storage unit 17843 stores the following learning data. That is, the learning data is data obtained by learning a histogram from signals having a plurality of optical signal to noise ratios (OSNRs) for each transmission format (modulation scheme). In the example illustrated in FIG. 18, the learning data storage unit 17843 stores learning data for OSNR=20, 19, . . . for the modulation scheme of each of QPSK, 16QAM, and 64QAM. Note that the learning data storage unit 17843 may further store learning data for other modulation schemes.

Each of the identification unit (X polarized wave) 17856 and the identification unit (Y polarized wave) 17857 performs nearest neighbor search processing using the histogram generated from the received signal and the histogram of the learning data. Each of the identification unit (X polarized wave) 17856 and the identification unit (Y polarized wave) 17857 sets a modulation scheme corresponding to the learning data having the minimum distance from the histogram generated from the received signal as a result of identification. As a method of identification, not only the nearest neighbor search exemplified here but also an approximate nearest neighbor search or an identification algorithm of another method may be used.

According to the present embodiment, processing of identifying the modulation scheme on the basis of learning data is implemented.

Although the plurality of embodiments have been described above, any of the following modifications can be further implemented.

### [Modification 1]

In the above embodiment, the orchestrator (function control unit) is included in the transmission apparatus. As a modification, the orchestrator may be implemented as an independent apparatus separate from the transmission apparatus. In this case, the orchestrator (function control apparatus) includes the function control unit. The function control unit receives, from a transmission apparatus, information on a result of identification of at least one of the modulation scheme, the frame format, or the encoding scheme identified on the basis of a characteristic of a signal received by the transmission apparatus, and performs control to cause a signal processing function to operate in the transmission apparatus, the signal processing function depending on the result of identification received.

### [Modification 2]

In the above embodiment, the transmission apparatus adaptively identifies the scheme for all of the modulation scheme, the frame format, and the encoding scheme, and causes a function depending on a result of the identification to operate. As a modification, the transmission apparatus may identify the scheme only for at least one of the modulation scheme, the frame format, or the encoding scheme, and cause a function depending on a result of the identification to operate.

### [Modification 3]

In the above embodiment, the communication system 8 (see FIG. 2) includes the station building side apparatus (transmission apparatus) 1 and the user terminal apparatus 2. Then, the station building side apparatus has a control function of identifying the modulation scheme, the frame format, or the encoding scheme on the basis of the received signal and causing a function depending on a result of identification to operate. Similarly, the user terminal apparatus side may have a control function of identifying the modulation scheme, the frame format, or the encoding scheme on the basis of the received signal and causing a function depending on a result of identification to operate.

According to any of the embodiments (including the modifications) described above, a blind adaptive switching function of a reception scheme is implemented in the softwarization of functions of the transmission apparatus. Such a transmission apparatus is effective in implementing the optical access system, but the above-described embodiments may be applied to a communication system other than the optical access system.

### INDUSTRIAL APPLICABILITY

The present invention can be used, for example, to perform communication of information. However, the use range of the present invention is not limited to that exemplified herein.

### REFERENCE SIGNS LIST

1 Station building side apparatus (transmission apparatus)
2, 2A, 2B, 2C User terminal apparatus
3 Higher-level side apparatus
4 Management apparatus
8 Communication system
11, 12, 13, 14, 15, 16 Station building side apparatus (transmission apparatus)
101 Signal capturing unit
102 Scheme identification unit
106 DSP demodulation unit
107 Decoding unit
108 Orchestrator (function control unit)
1101 Signal capturing unit
1102 Scheme identification unit
1109 Parameter change unit
1121 MC interface
1122 PON interface
1123 ADC interface
1131 Preprocessing unit
1132 Inference unit
1133 Parameter storage unit
1161a QPSK demodulation unit
1161b 16QAM demodulation unit
1161c DP-QPSK demodulation unit
1162a Ether frame detection unit
1162b Video frame detection unit
1162c PON frame detection unit
1163a RS decoding unit
1163b LDPC decoding unit
1201 Signal capturing unit
1203 Modulation scheme identification unit
1203 Modulation scheme identification unit
1204 Frame identification unit
1205 Encoding identification unit
1209 Parameter change unit
1221 MC interface
1222 PON interface
1223 ADC interface
1231 Preprocessing unit
1232 Inference unit
1233 Parameter storage unit
1241 Preprocessing unit
1242 Inference unit
1243 Parameter storage unit
1251 Preprocessing unit
1252 Inference unit
1253 Parameter storage unit
1261a QPSK demodulation unit
1261b 16QAM demodulation unit
1261c DP-QPSK demodulation unit
1262a Ether frame detection unit
1262b Video frame detection unit
1262c PON frame detection unit
1263a RS decoding unit
1263b LDPC decoding unit
1301 Signal capturing unit
1303 Modulation scheme identification unit
1304 Frame identification unit
1305 Encoding identification unit
1309 Parameter change unit
1321 MC interface
1322 PON interface
1323 ADC interface
1341 Identification processing unit
1343 Parameter storage unit
1351 Identification processing unit
1353 Parameter storage unit
1361a QPSK demodulation unit
1361b 16QAM demodulation unit
1361c DP-QPSK demodulation unit
1362a Ether frame detection unit
1362b Video frame detection unit
1362c PON frame detection unit
1363a RS decoding unit
1363b LDPC decoding unit
1401 Signal capturing unit
1403 Modulation scheme identification unit
1404 Frame identification unit
1405 Encoding determination unit
1409 Parameter change unit
1421 MC interface
1422 PON interface
1423 ADC interface
1461a QPSK demodulation unit
1461b 16QAM demodulation unit
1461c DP-QPSK demodulation unit
1462a Ether frame detection unit
1462b Video frame detection unit
1462c PON frame detection unit
1463a RS decoding unit
1463b LDPC decoding unit
1471 Encoding scheme storage unit
1501 Signal capturing unit
1503 Modulation scheme identification unit
1504 Frame identification unit
1505 Encoding identification unit
1509 Parameter change unit
1521 MC interface
1522 PON interface
1523 ADC interface
1561a QPSK demodulation unit
1561b 16QAM demodulation unit
1561c DP-QPSK demodulation unit
1562a Ether frame detection unit
1562b Video frame detection unit
1562c PON frame detection unit
1563a RS decoding unit
1563b LDPC decoding unit
1572 Orchestrator (function control unit)
1601 Signal capturing unit
1603 Modulation scheme identification unit
1623 ADC interface
1661 Symbol decision unit
1662 Frame detection unit
1663 Decoding unit
1681 Clock synchronization unit
1682 Polarization separation and adaptive filter unit
1683 Carrier phase recovery unit
1684 Shared memory
1685 Thread processing unit
1686 Filter coefficient update unit
1687 Histogram addition unit
1688 Polarization multiplicity identification unit
1784 Shared memory
1785 Identification unit
16841 Filter coefficient storage unit
16842 Amplitude histogram storage unit
16851 Adaptive filter
16852 Amplitude histogram information generation unit
16853 Quantization unit
16854 Normalization unit (X polarized wave)
16855 Normalization unit (Y polarized wave)
16856 Identification unit (X polarized wave)
16857 Identification unit (Y polarized wave)
17343 Learning data storage unit
17856 Identification unit (X polarized wave)
17857 Identification unit (Y polarized wave)

1. A transmission apparatus comprising:
a scheme identification unit configured to identify at least one of a modulation scheme, a frame format, or an encoding scheme on a basis of a characteristic of a signal received;
a function control unit configured to perform control to cause a signal processing function to operate, the signal processing function depending on a result of identification of the at least one of the modulation scheme, the frame format, or the encoding scheme by the scheme identification unit; and
a signal processing unit configured to be controlled to operate by the function control unit and process the signal received.

2. The transmission apparatus according to claim 1, wherein
the function control unit is configured to activate a signal processing function depending on the result of identification and allocate a resource for the signal processing function to operate.

3. The transmission apparatus according to claim 1, wherein
the scheme identification unit is configured to identify a modulation scheme of the signal received on a basis of a frequency distribution of amplitudes of the signal received, and
the function control unit is configured to perform control to cause a demodulation function to operate, the demodulation function depending on the modulation scheme identified by the scheme identification unit.

4. The transmission apparatus according to claim 1, wherein
the scheme identification unit is configured to identify a frame format of the signal received on a basis of a bit string pattern of a preamble included in the signal received, and
the function control unit is configured to perform control to cause a frame detection function to operate, the frame detection function depending on the frame format identified by the scheme identification unit.

5. The transmission apparatus according to claim 1, wherein
the scheme identification unit is configured to perform processing of demodulation of a code included in a frame detected from the signal received, and identify an encoding scheme of the signal received on a basis of an amount of errors generated by the processing of demodulation, and
the function control unit is configured to perform control to cause a decoding function to operate, the decoding function depending on the encoding scheme identified by the scheme identification unit.

6. A function control apparatus comprising:
a function control unit that configured to receive, from a transmission apparatus, information on a result of identification of at least one of a modulation scheme, a frame format, or an encoding scheme identified on a basis of a characteristic of a signal received by the transmission apparatus, and perform control to cause a signal processing function to operate in the transmission apparatus, the signal processing function depending on the result of identification received.

7. A system comprising a terminal apparatus and a transmission apparatus, wherein
the terminal apparatus is configured to transmit a signal to the transmission apparatus, and
the transmission apparatus includes:
a scheme identification unit that configured to identify at least one of a modulation scheme, a frame format, or an encoding scheme on a basis of a characteristic of a signal received from the terminal apparatus;
a function control unit that configured to perform control to cause a signal processing function to operate, the signal processing function depending on a result of identification of the at least one of the modulation scheme, the frame format, or the encoding scheme by the scheme identification unit; and
a signal processing unit configured to be controlled to operate by the function control unit and process the signal received.

8. A signal processing method, comprising:
identifying at least one of a modulation scheme, a frame format, or an encoding scheme on a basis of a characteristic of a signal received;
performing control to cause a signal processing function to operate, the signal processing function depending on a result of identification of the at least one of the modulation scheme, the frame format, or the encoding scheme by the scheme identification unit; and
performing control to cause the signal processing function to operate depending on the result of identification, and process the signal received.
